(19) United States
(12) Patent Application Publication
(10) Pub. No.: US 2018/0272810 A1
(43) Pub. Date: Sep. 27, 2018

(54) Tire Comprising a Block With a Tilted Side Wall

(71) Applicant: COMPAGNIE GENERALE DES ETABLISSEMENTS MICHELIN, Clermont-Ferrand (FR)

(72) Inventors: Daniel FABING, Clermont-Ferrand Cedex 9 (FR); IIIyes BATNINI, Clermont-Ferrand Cedex 9 (FR); Sébastien DUCHEMIN, Clermont-Ferrand Cedex 9 (CN); Jeoffrey BUSA, Clermont-Ferrand Cedex 9 (FR)

(21) Appl. No.: 15/765,000

(22) PCT Filed: Nov. 14, 2016
(86) PCT No.: PCT/FR2016/052939

§ 371 Date: Mar. 30, 2018

(30) Foreign Application Priority Data
Nov. 16, 2015 (FR) 1560941

(51) Int. Cl. B60C 11/03; B60C 11/13

(52) U.S. Cl. CPC B60C 11/0316; B60C 2011/0372; B60C 11/1315; B60C 11/0302

(57) ABSTRACT

Tire made of rubbery material comprising a tread (1) of width W that is delimited by at least one edge (3). The tread comprises a plurality of blocks (5), each block being delimited by at least one lateral wall (7) that extends mainly in an axial direction Y in the direction of the edge (3). The lateral wall (7) has a length L in this axial direction Y, where L is greater than 35% of the width W of the tread. The lateral wall also exhibits an inclination angle (a) with respect to a radial direction (Z), said inclination angle (a) evolving in the axial direction Y, this evolution being continuous.

### FIELD OF THE INVENTION

The present invention relates to a tire for a motor vehicle, comprising a tread comprising at least one block, this block having at least one inclined lateral wall.

### PRIOR ART

The document U.S. Pat. No. 4,884,607 discloses a tire comprising a tread, this tread being provided with a plurality of rubber blocks. The rubber blocks are organized in the tread such that this tread is referred to as directional. The rubber blocks are also organized so as to form, in the tread, circumferential grooves and generally transverse grooves. The transverse grooves notably have the role of evacuating water from the tread when the tire is rolling on a wet road surface. In order to improve this evacuation of water, the document U.S. Pat. No. 4,884,607 specifies that the cross sections of the transverse grooves widen in the direction of the edges of the tread. This widening is notably rendered possible by the inclination of the lateral walls of the blocks that delimit the grooves (see FIG. 2A, FIG. 2B and FIG. 2C of the document U.S. Pat. No. 4,884,607). Specifically, for a given transverse groove, each block lateral wall delimiting this groove has its own inclination angle. The inclination of the lateral walls of the blocks decreases away from the centre of the tread so as to increase the cross sections of the transverse grooves.

However, such an arrangement of rubber blocks, having different inclination angles as a function of the distance with respect to the centre of the tread, appears to contribute towards the development of a non-uniform wear profile on this tread during rolling. Notably, it has been found that the wear to the blocks close to the edge regions of the tread is greater notably when the tire is mounted on a directional axle. Similarly, it has been found that the wear to the blocks close to the centre of the tread is greater notably when the tire is mounted on a driven axle.

Therefore, there is a need to improve the wear profile of a tread of a tire, while maintaining a high grip capacity of this tread on a wet road surface.

### Definitions

A “tire” means all types of resilient tread, whether or not it is subjected to an internal pressure.

The “tread” of a tire means a quantity of rubbery material delimited by lateral surfaces and by two main surfaces, one of which is intended to come into contact with a road surface when the tire is being driven on.

The “edge” of the tread means one of the lateral surfaces delimiting the tread.

The “width W of the tread” means the distance between the two edges flanking the tread. This distance is defined by the ETRTO standard. It is thus equal to +/−10% of a nominal width Wnom, where Wnom is equal to (1.075-0.005ar)*S^{1.001}, where ar is the nominal aspect ratio expressed in base 100 and s is the theoretical section width on the measuring rim expressed in mm.

A “block of a tread” means a raised element delimited by recesses or grooves and comprising lateral walls and a contact face, the latter being intended to come into contact with a road surface during rolling.

A “directional tread pattern” means a tread pattern in which the blocks are specifically arranged to optimize the behavioural characteristics as a function of a predetermined sense of rotation. This sense of rotation is conventionally indicated by an arrow on the sidewall of the tire. In such an architecture, the edges of the blocks which face in the sense of the rolling direction are denoted by the term “leading edges”, while the edges of the blocks which face away from the rolling direction are denoted by the term “trailing edges”.

A “continuous evolution” of the inclination angle of a lateral wall means that the inclination angle is a function of a distance measured from the centre of the tread. The function used is continuous. This function may be, for example, a polynomial, exponential or Gaussian function.

A “sipe” means a cutout in which the distance between the walls of material is appropriate to allow the opposite walls delimiting said sipe to come into at least partial contact when in the contact patch in which the tire is in contact with the ground. This distance for a sipe is in this case at most equal to 2 millimetres (mm).

A “groove” means a cutout in which the distance between the walls of material is such that these walls cannot come into contact with one another under normal rolling conditions. This distance for a groove is greater than 2 millimetres (mm).

A “radial direction” means a direction which is perpendicular to the axis of rotation of the tire (this direction corresponds to the direction of the thickness of the tread).

An “axial direction” means a direction parallel to the axis of rotation of the tire.

A “circumferential direction” means a direction tangential to any circle centred on the axis of rotation. This direction is perpendicular both to the axial direction and to the radial direction.

### SUMMARY OF THE INVENTION

The invention relates to a tire made of rubbery material comprising a tread of width W that is delimited by at least one edge (3). The tread comprises a plurality of blocks, each block being delimited by at least one lateral wall that extends mainly in an axial direction Y in the direction of the edge. The lateral wall has a length L in this axial direction Y, where L is greater than 35% of the width W of the tread. The lateral wall exhibits an inclination angle with respect to a radial direction, said inclination angle evolving in the axial direction Y, this evolution being continuous.

It has been found that continuous evolution of the inclination angle of the lateral wall of the block makes it possible to obtain a more regular wear profile on the block. In particular, the greater the inclination angle of the lateral wall, the greater the wear to the block at this lateral wall. Thus, by controlling the value of the inclination angle while making this variation in inclination continuous, it is possible to direct the wear to the tread to one part or another of the block with a view to better distribution of this wear. In this way, a situation in which parts of the tire become worn prematurely is avoided and consequently the mileage is improved.

In a preferred embodiment, the evolution of the inclination angle is in accordance with a Gaussian curve.

With an evolution in accordance with a Gaussian curve, the inclination angle has a maximum value half-way along the length L of the block. When the block extends across half the width of the tread, the invention favours wear in a region centred on the half-tread. By favouring such wear, the mileage of a tire is improved regardless of whether it is mounted on a driven axle or on a directional axle.

In another embodiment, the evolution of the inclination angle is in accordance with a polynomial function.

In another embodiment, the evolution of the inclination angle is in accordance with an exponential function.

In another embodiment, the tread having a centre, the block extends from the centre of said tread to the edge along a curve C.

In this way, the evacuation of water in the direction of the edge of the tread is favoured. This improves the grip of the tire on a wet road surface.

In another embodiment, each block is divided into a plurality of block segments.

In another embodiment, the lateral wall delimits a groove that extends towards the edge of the tread, the groove having a cross section, the cross section of said groove increasing in the direction of this edge.

By widening the cross section of the groove, the evacuation of water from the tread is improved there, too.

In another embodiment, the values of the inclination angle are between −10° and 30°.

With an inclination angle close to −10°, good grip on a wet and/or snow-covered road surface is ensured. With an inclination angle close to 30°, the grip on a dry road surface is improved. Thus, by providing a relatively wide range of inclination angle values, it is possible to easily adapt the characteristics of the tread to the type of grip desired.

In a preferred embodiment, the inclination angle being able to have a maximum value and a minimum value, the difference between this maximum value and this minimum value is at least 10°.

The inventors have found that there needs to be at least a difference of 10° between the maximum value and the minimum value in order for the effect on the wear to the thread to be appreciable.

The maximum value of the inclination angle is 15° and its minimum value is 5°.

The inventors have found that, with such a characteristic of the inclination angle, the retention of stones in the groove delimited by the lateral wall is limited.

In a preferred embodiment, the block is delimited by another lateral wall, this other lateral wall exhibiting an inclination angle that evolves continuously.

This makes it possible to obtain a regular wear profile on the block, both in its leading part and in its trailing part.

In a preferred embodiment, the tread is directional and the block has a leading edge belonging to the lateral wall of this block. The block also has a trailing edge belonging to the other lateral wall of the block. The maximum value of the inclination angle of the lateral wall that forms the trailing edge is greater than the maximum value of the inclination angle of the lateral wall that forms the leading edge.

This optimizes the function of the tread as a function of its rolling sense. When the vehicle accelerates, it is the leading edge of the block that comes into contact with the ground first. On a wet road surface, when accelerating, the aim is thus to favour the evacuation of water from the tread. By contrast, when the vehicle brakes, it is the trailing edge of the block which acts. By giving this trailing edge a greater inclination angle value, braking is favoured, notably on a dry road surface.

In a preferred embodiment, the block has a chamfered part at its lateral wall.

Transverse grip, notably when cornering, on a snow-covered and/or wet road surface is thus favoured.

In a preferred embodiment, the lateral wall of the block has one or more discontinuities.

The discontinuities in the lateral wall further favour the transverse grip on a snow-covered and/or wet road surface.

### BRIEF DESCRIPTION OF THE DRAWINGS

Further features and advantages of the invention will become apparent from the following description, given by way of non-limiting example, with reference to the attached drawings in which:

FIG. 1 schematically shows a partial view of a tread of a tire according to the invention;

FIG. 2 shows a view in cross section on A-A′ of a block of the tread in FIG. 1;

FIG. 3 shows a schematic view of the evolution of an inclination angle of a lateral wall of the block in FIG. 2;

FIG. 4 shows a partial view of a tread of a tire according to a second embodiment of the invention;

FIG. 5 shows a partial view of a tread of a tire according to a third embodiment of the invention;

FIG. 6 shows a variant embodiment according to a fourth embodiment of the invention;

FIG. 7 shows a variant embodiment according to a fifth embodiment of the invention;

FIG. 8 shows a variant embodiment according to a sixth embodiment of the invention.

In the following description, elements which are substantially identical or similar will be denoted by identical references.

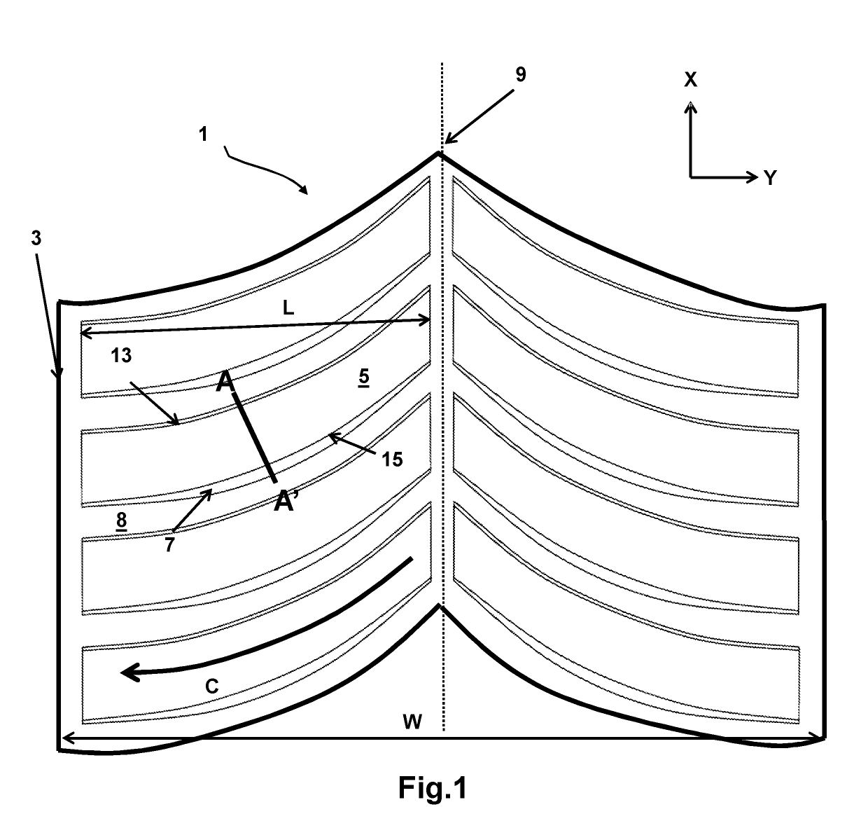

FIG. 1 schematically presents a partial view of a tread 1 of a tire according to the invention. The tread 1 is delimited by two edges 3 and a centre 9 separating the tread into two ½ treads. This tread 1 has a width W measured between these two edges 3. This width W is determined to be equal to +/−10% of a nominal width Wnom. This nominal width Wnom is determined with the aid of the following formula: Wnom=(1.075−0.005*ar)*S^{1.001} where ar is the nominal aspect ratio expressed in base 100 and S is the theoretical section width on the measuring rim expressed in mm Thus, for a tire of size 205/55 16, Wnom is equal to (1.075−0.005*55)*(205)^{1.001}=165 mm.

The tread 1 also comprises a plurality of raised rubber blocks 5. These rubber blocks 5 are organized in the tread so as to form a particular tread pattern design. In the embodiment in FIG. 1, the rubber blocks 5 extend from the centre 9 of the tread 1 to respective edges 3, specifically along a curve C. The tread pattern formed is referred to as directional in this case. Thus, each rubber block 5 has a leading edge 13 and a trailing edge 15. The leading edge 13 is that part of the block 5 that will come into contact with a road surface first during acceleration of the vehicle. The trailing edge 15 is that part of the block 5 that will come into contact first during braking. In a variant, the organization of the rubber blocks 5 could be different; for example, the tread pattern formed by these blocks 5 could be non-directional.

Each block is delimited by at least one lateral wall 7. This lateral wall 7 delimits a groove 8 which extends mainly in an axial direction Y in the direction of the edge region 3. It will be noted that the lateral wall 7 has a length L in this axial direction Y, where L is greater than 35% of the width W of the tread. It will also be noted that, in a preferred embodiment, the cross section of the groove 8 increases in the direction of the edge 3. In the example in FIG. 1, where the tread pattern is directional, the lateral wall 11 delimits the leading edge 13 and the lateral wall 7 on the opposite side from the lateral wall 11 in the block 5 delimits the trailing edge.

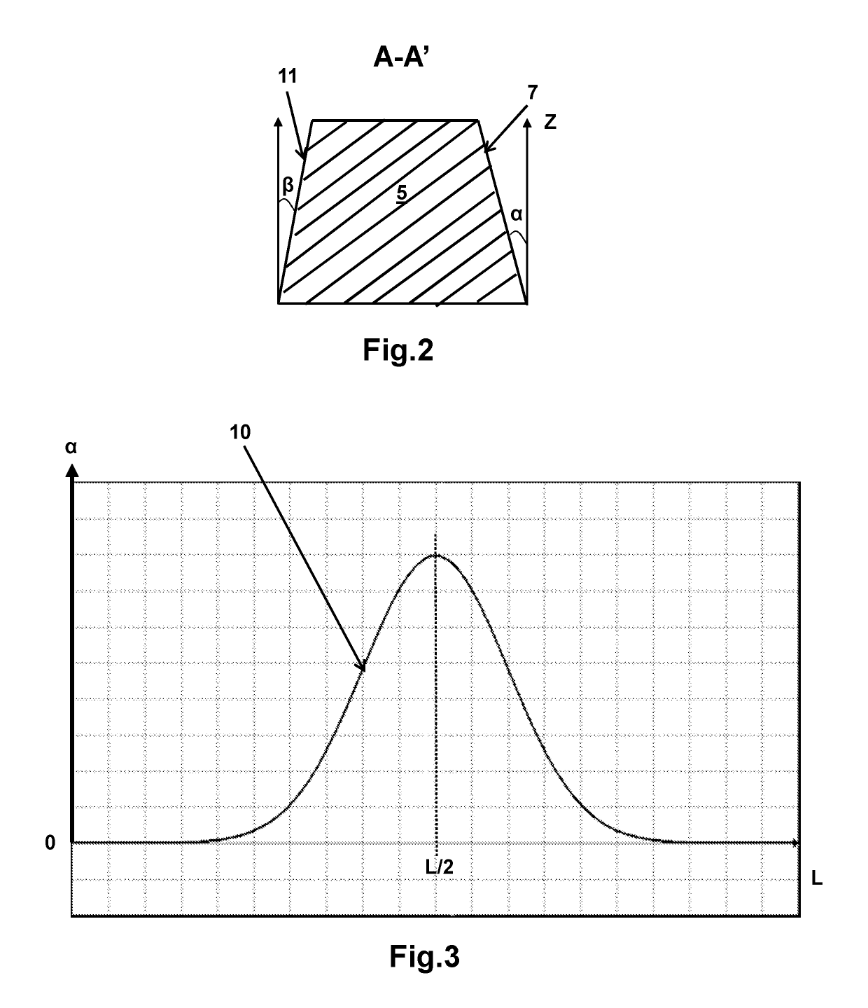

FIG. 2 presents a view in cross section on A-A′ of a block 5 of the tread 1. More particularly, the lateral wall 11 of the block 5 forms an inclination angle α with respect to a radial direction Z. This inclination angle α evolves in the axial direction Y in FIG. 1, this evolution being continuous in this axial direction. The lateral wall 7, on the opposite side from the lateral wall 11, for its part forms an inclination angle β with respect to the radial direction Z. The evolution in the inclination angle may, for its part, also be continuous in the axial direction Y. The inclination angles α and β have values of between −10° and 30°. It will be noted that when the value of the angle is negative, the width of the groove associated with the lateral wall increases with depth into this groove. Conversely, when the value of the angle is positive, the width of the associated groove decreases with depth into the groove.

In a preferred embodiment, the evolutions of the inclination angles α, β are in accordance with a Gaussian curve 10, as is shown in FIG. 3. In this FIG. 3, it can be seen that the values of the inclination angles α and β are at a maximum at L/2, i.e. half-way across the half-tread.

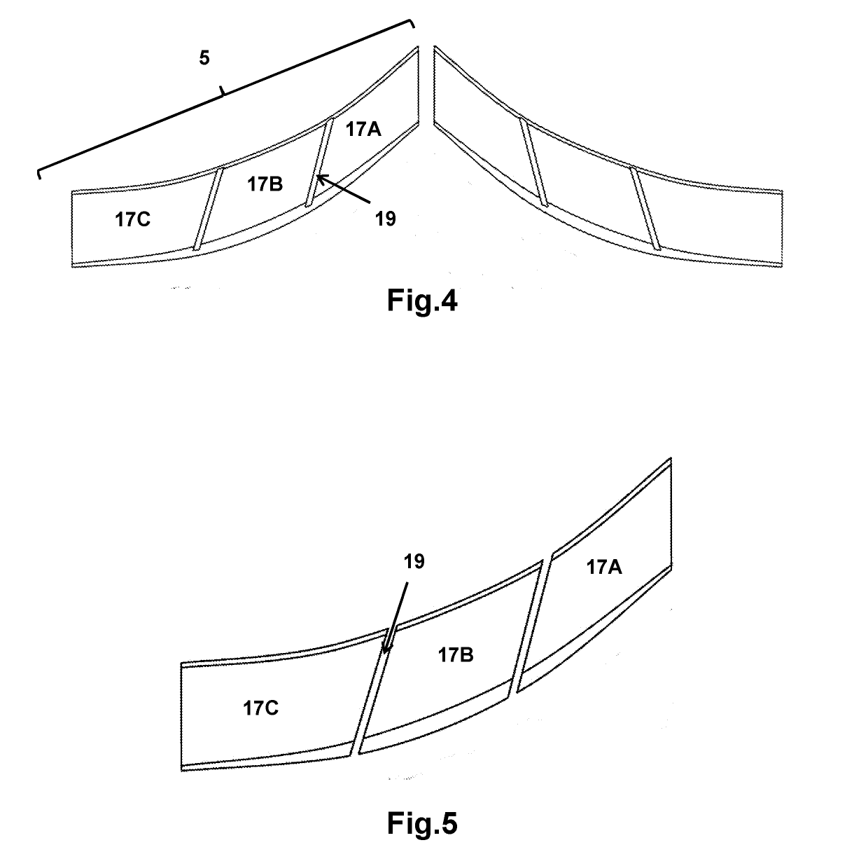

FIG. 4 presents an alternative embodiment in which the block 5 is divided into a plurality of sub-blocks 17a, 17b, 17c separated by secondary grooves 19. These secondary grooves extend mainly in a circumferential direction X. In this example, the grooves 19 do not extend all the way into the depth of the tread, such that the walls 7 and 11 extend continuously from the centre of the tread to the edge.

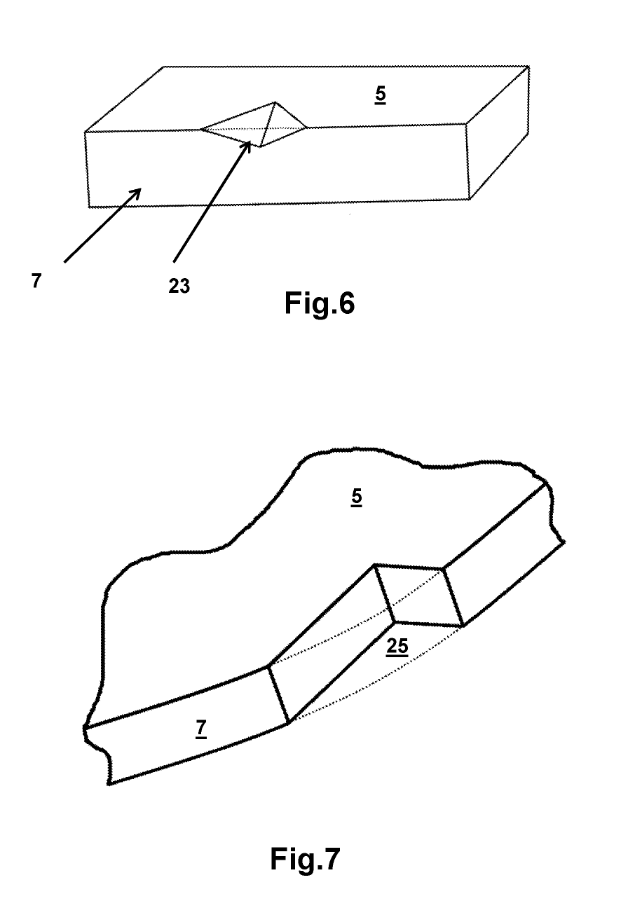

In a variant embodiment shown in FIG. 5, the grooves 19 extend all the way into the depth of the tread, such that the sub-blocks 17a, 17b, 17c are clearly separated. Thus, the walls 7 and 11 do not in this case extend continuously from the centre of the tread to the edge, since the grooves 19 create discontinuities. However, the evolution of the inclination angles of these walls 7, 11 is continuous, since these angles remain a function of a distance measured from the centre of the tread.

In an alternative embodiment, the block 5 has a chamfered part 23 at its lateral wall, as can be seen in FIG. 6.

In another embodiment, which can be seen in FIG. 7, the lateral wall 7 of the block 5 has one or more discontinuities 25. In the same way here, the evolution of the inclination angle of the wall 7 is continuous, since this angle remains a function of a distance measured from the centre of the tread.

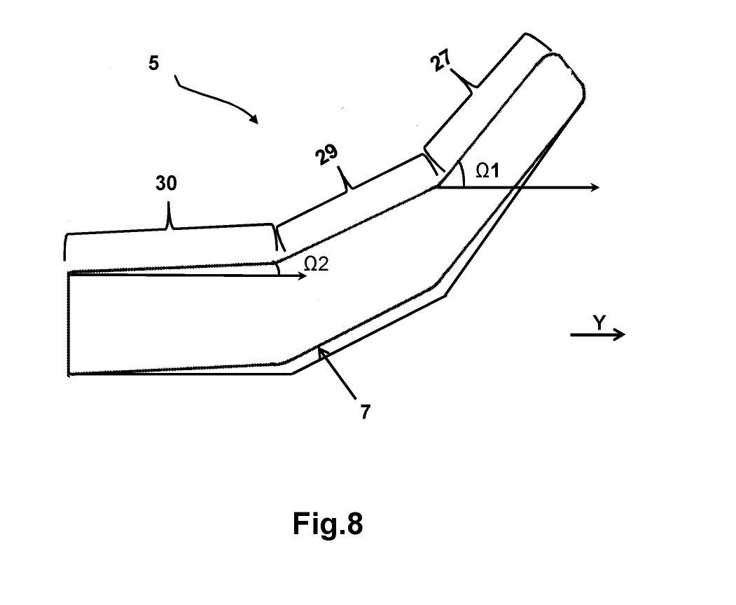

In another embodiment, which can be seen in FIG. 8, each block 5 is divided into a plurality of block segments 27, 29, 30. More particularly, the block 5 comprises a central segment 27 that extends generally at an angle Ω1, such that 35°≤Ω1≤65° to a transverse direction Y. The block 5 also comprises an edge segment 30 that extends generally at an angle Ω2 such that 0°≤Ω2≤10° to the transverse direction Y. The block 5 finally comprises a joining segment 29 between the central segment 27 and the edge segment 30.

The invention is not limited to the examples described and shown and various modifications can be made thereto without departing from its scope.

1. A tire made of rubbery material, comprising a tread of width W that is delimited by at least one edge, the tread comprising a plurality of blocks, each said block being delimited by at least one lateral wall that extends mainly in an axial direction Y in the direction of the edge, the lateral wall having a length L in this axial direction, where L is greater than 35% of the width W of the tread, wherein the lateral wall exhibits an inclination angle (α) with respect to a radial direction, said inclination angle (a) evolving in the axial direction Y, said evolution being continuous.

2. The tire according to claim 1, wherein the evolution in the inclination angle (a) is in accordance with a Gaussian function.

3. The tire according to claim 1, wherein the evolution in the inclination angle (a) is in accordance with a polynomial function.

4. The tire according to claim 1, wherein the evolution in the inclination angle (a) is in accordance with an exponential function.

5. The tire according to claim 1, wherein, the tread having a centre, the block extends from the centre of said tread to the edge along a curve C.

6. The tire according to claim 1, wherein, each said block is divided into a plurality of block segments.

7. The tire according to claim 1, wherein, the lateral wall delimits a groove that extends towards the edge of the tread, the groove having a cross section, the cross section of said groove increases in the direction of this said edge.

8. The tire according to claim 1, wherein the values of the inclination angle (a) are between −10° and 30°.

9. The tire according to claim 1, wherein, the inclination angle (a) being able to have a maximum value and a minimum value, the difference between this maximum value and this minimum value is at least 10°.

10. The tire according to claim 9, wherein the maximum value of the inclination angle is 15° and its minimum value is 5°.

11. The tire according to claim 1, wherein the block is delimited by another lateral wall, said other lateral wall exhibiting an inclination angle (β) that evolves continuously.

12. The tire according to claim 11, wherein, the tread being directional, the block has a leading edge belonging to the lateral wall of said block and the block has a trailing edge belonging to the other lateral wall of the block, the maximum value of the inclination angle (a) of the lateral wall that forms the trailing edge being greater than the maximum value of the inclination angle (β) of the lateral wall that forms the leading edge.

13. The tire according to claim 1, wherein the block is divided into a plurality of sub-blocks separated by secondary grooves that extend mainly in a circumferential direction.

14. The tire according to claim 1, the block has a chamfered part at its lateral wall.

15. The tire according to claim 1, wherein the lateral wall of the block has one or more discontinuities.
